(19) United States
(12) Patent Application Publication
(10) Pub. No.: US 2003/0104731 A1
(43) Pub. Date: Jun. 5, 2003

(54) Resilient reinforcing structure for contact plate of an electronic connector

(76) Inventor: Chi-Yao Chang, Kuishan Hsiang (TW)

Correspondence Address: TROXELL LAW OFFICES PLLC, SUITE 1404, 5205 LEESBURG PIKE, FALLS CHURCH, VA, 22401, US

(21) Appl. No.: 09/997,011

(22) Filed: Nov. 30, 2001

(51) Int. Cl. H01R 4/48

(52) U.S. Cl. 439/862

(57) ABSTRACT

Resilient reinforcing structure for contact plate of an electric connector, including a contact plate. A front section of the contact plate is formed with a bent contact section. The middle portion of the contact plate is formed with a resilient arm. A rear end of the contact plate is formed with a connecting end fixedly connected in a seat body. A rear side of the contact plate is provided with a resilient reinforcing arm for resiliently pressing the back side of a portion of the resilient arm which suffers a force. Accordingly, the reinforcing arm provides an enhanced resilient stopping effect for the contact plate and provides sufficient forward resilient pressing force for the contact plate to minimize the deformation thereof when suffering a force. Also, the elastic failure caused by over-deformation of the resilient arm can be effectively avoided.

### BACKGROUND OF THE INVENTION

The present invention is related to a resilient reinforcing structure for contact plate of an electric connector. The reinforcing structure is able to enhance the resilient contacting force of the contact plate and avoid deformation of the contact plate caused by over-forcing.

The contact plate of a conventional electric connector serves to electrically contact with the contact point of an inserted device. The conventional electric connector includes a seat body and a contact plate. The seat body is formed with multiple receiving cavities extending in parallel to each other. The bottoms of the cavities are connected by at least one base section. The contact plate includes a straight resilient body and a bent pressing section formed at the free end of the resilient body. The rear section of the contact plate is fixed in the base section of the seat body. The middle of the contact plate is formed with a resilient arm, whereby the free end can be fully resiliently biased. The rear end of the contact plate protrudes from lower side of the base section to form a soldering end for connecting with a circuit board. The bent pressing section protrudes from an opening of the receiving cavity. A space for deflection is defined behind the bent pressing section.

When not suffering a force, the resilient body is in a naturally straight state. When the bent pressing section suffers an external force and is rearward pressed, the bent pressing section of the contact plate keeps contacting with the contact point of an inserted object. The resilient arm and the bent pressing section are curved and deformed to together absorb the pressure of the inserted object. However, the deformed section of the resilient arm is slender and weak and has poor strength against the deformation. As a result, after a period of use, elastic failure of the resilient arm often takes place and the resilient arm itself is unable to restore to its home position. Accordingly, the bent pressing section can hardly provide sufficient contacting force so that the electric connection will be poor.

### SUMMARY OF THE INVENTION

It is therefore a primary object of the present invention to provide a resilient reinforcing structure for contact plate of an electric connector. The reinforcing structure includes a resilient reinforcing arm which is formed on back side of the contact plate to keep abutting against the back face of the resilient arm of the contact plate. Therefore, the reinforcing arm always provides an auxiliary resiliently forward pressing effect for the resilient arm. Therefore, the deformation of the resilient arm and the bent pressing section can be reduced. Also, the elastic failure caused by over-deformation of the resilient arm can be effectively avoided.

According to the above object, the resilient reinforcing structure for contact plate of an electric connector includes a contact plate. A front section of the contact plate is formed with a bent contact section. The middle portion of the contact plate is formed with a resilient arm. A rear end of the contact plate is formed with a connecting end fixedly connected in a seat body. A rear side of the contact plate is provided with a resilient reinforcing arm. The free end of the reinforcing arm right resiliently presses the back side of a portion of the resilient arm which suffers a force and is bent. Accordingly, the reinforcing arm keeps resiliently pressing the resilient arm and provide an auxiliary resilient stopping effect for the resilient arm to minimize the deformation thereof. Also, the elastic failure caused by over-deformation of the resilient arm can be avoided.

The present invention can be best understood through the following description and accompanying drawings wherein:

### BRIEF DESCRIPTION OF THE DRAWINGS

FIG. 1 is a perspective view of the present invention;

FIG. 2 is a side view of the present invention; and

FIG. 3 is a side view showing the operation of the present invention.

### DETAILED DESCRIPTION OF THE PREFERRED EMBODIMENTS

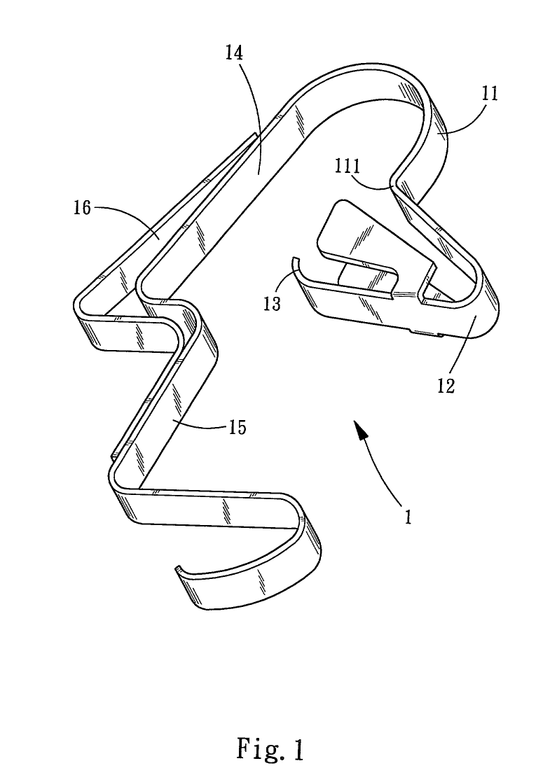

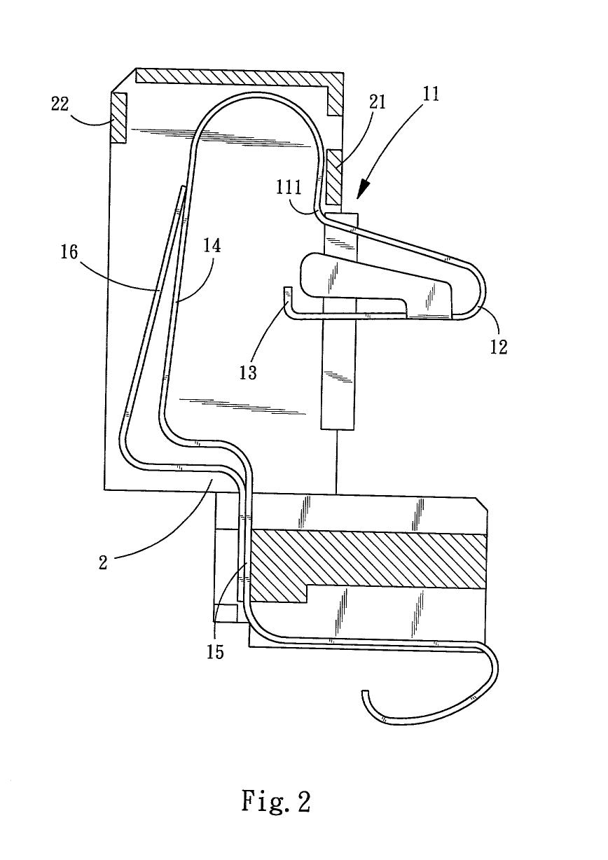

Please refer to FIGS. 1 and 2. The present invention includes a contact plate 1 and a seat body 2. The front section of the contact plate 1 is formed with a forward extending contact section 11. The contact section 11 has a bent section 111 bent in contacting direction. The front end of the bent section 111 adjoins with a bight projecting section 12 in the contacting direction. The free end of the bight projecting section 12 is formed with an inward bending end 13. The middle of the contact plate 1 is formed with a straight resilient arm 14. The rear end of the contact plate 1 is formed with a connecting end 15 for connecting on the seat body 2.

The present invention is characterized in that the rear side of the contact plate 1 is provided with a resilient reinforcing arm 16. The heel end of the reinforcing arm 16 is fixed on the seat body 2. The free end of the reinforcing arm 16 upward extends from the heel end and is bent toward the resilient arm 14 of the contact plate 1. The reinforcing arm 16 partially resiliently presses a portion of the rear face of the resilient arm 14 which suffers force and is subject to bending and deflection. Therefore, the reinforcing arm 16 helps in resiliently stopping the resilient arm 14 from being rearward biased.

The seat body 2 is connected with the contact plate 1 and the resilient reinforcing arm 16. The seat body 2 is formed with deflection-buffering space corresponding to the forward and rearward deflected position of the bent section 111 and bight projecting section 12 of the contact plate 1. In addition, a front stop section 21 is disposed on front side of the space for restricting the forward pressing extent of the contact section 11. A rear stop section 22 is disposed on rear side of the seat body 2. Another buffering space is defined between the rear stop section 22 and the straight resilient arm 14. The rear stop section 22 just stops and restricts the backing path of the resilient arm 14 within a bearable range when suffering a force. Therefore, the resilient arm 14 is protected from being over-bent and deformed due to pressing force.

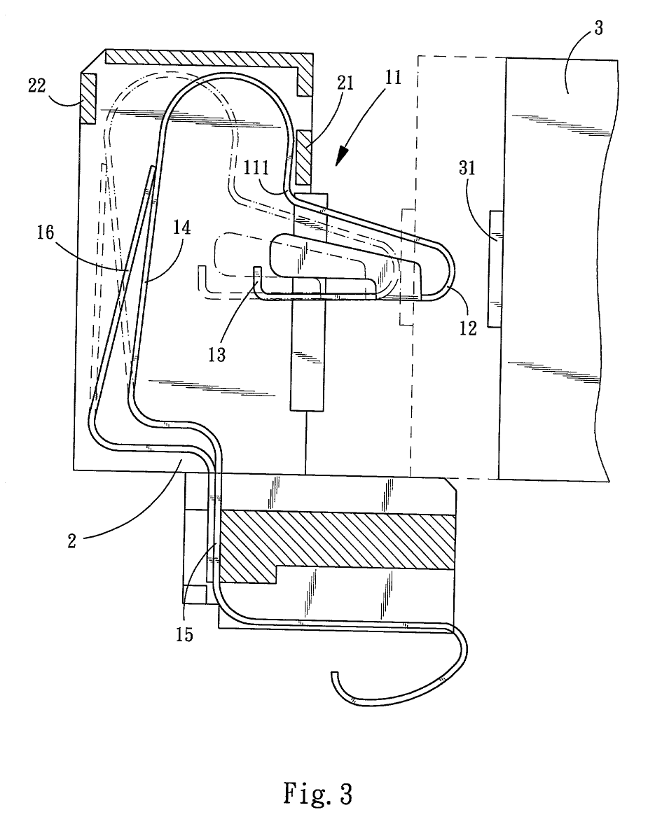

The reinforcing arm 16 can be independently manufactured. Alternatively, the reinforcing arm 16 and the contact plate 1 can be integrally made with the same material. The reinforcing arm 16 can be folded to the back face of the contact plate 1 from one side thereof. Such processing is easy. Moreover, the reinforcing arm 16 keeps abutting against the portion of the resilient arm 14 which suffers force and is subject to bending. Therefore, the reinforcing arm 16 is always able to provide a forward pressing effect for the resilient arm 14. Accordingly, when the resilient arm 14 suffers a force and is rearward biased, the reinforcing arm 16 is synchronously moved backward along with the resilient arm 14 (with reference to FIG. 3). When the force disappears, the resilient pressing force of the reinforcing arm 16 helps the resilient arm 14 to create stronger forward reverse pressing force, whereby the bight projecting section 12 can more tightly contact with the contact point 31 of the inserted object 3. Accordingly, the reinforcing arm 16 continuously provides excellent resilient pressing and stopping effect for the straight resilient arm 14 of the contact plate 1. Therefore, the deformation of the contact section 11 and the resilient arm 14 can be avoided. Also, the elastic failure caused by over-deformation of the resilient arm 14 can be effectively avoided. Accordingly, the contact section 11 can well contact with the contact point 31 of the inserted object 3.

The above embodiments are only used to illustrate the present invention, not intended to limit the scope thereof. Many modifications of the above embodiments can be made without departing from the spirit of the present invention.

What is clamed is:

1. Resilient reinforcing structure for contact plate of an electric connector, comprising a contact plate, a front section of the contact plate being formed with a forward extending contact section, a middle portion of the contact plate being formed with a straight resilient arm with a certain length, a rear end of the contact plate being formed with a connecting end fixedly connected in a seat body, said resilient reinforcing structure being characterized in that a rear side of the contact plate is provided with a resilient reinforcing arm, a heel end of the reinforcing arm being fixed in the seat body, the other end of the reinforcing arm being a free end bent toward the back side of the resilient arm to stop and press a portion of the resilient arm which suffers a force and is subject to bending and deflection, whereby the reinforcing arm serves to enhance the resilience of the contact plate when suffering pressing force.

2. Resilient reinforcing structure as claimed in claim 1, wherein the resilient arm is backward folded from the contact plate and integrally formed on rear side of the contact plate.

3. Resilient reinforcing structure as claimed in claim 1, wherein the contact plate has a bight projecting section bent from the resilient arm in a contacting direction.

4. Resilient reinforcing structure as claimed in claim 2, wherein the contact plate has a bight projecting section bent from the resilient arm in a contacting direction.

5. Resilient reinforcing structure as claimed in claim 3, wherein a bent section is connected between the resilient arm and the bight projecting section.

6. Resilient reinforcing structure as claimed in claim 4, wherein a bent section is connected between the resilient arm and the bight projecting section.
